(19) United States
(12) Patent Application Publication
(10) Pub. No.: US 2025/0191835 A1
(43) Pub. Date: Jun. 12, 2025

(54) COIL COMPONENT

(71) Applicant: Murata Manufacturing Co., Ltd., Kyoto-fu (JP)

(72) Inventors: Masashi MIYAMOTO, Nagaokakyo-shi (JP); Kodai IWASA, Nagaokakyo-shi (JP); Tarou TSUJIBAYASHI, Nagaokakyo-shi (JP); Ryo NARAHARA, Nagaokakyo-shi (JP); Shogo TOKOI, Nagaokakyo-shi (JP)

(73) Assignee: Murata Manufacturing Co., Ltd., Kyoto-fu (JP)

(21) Appl. No.: 19/058,958

(22) Filed: Feb. 20, 2025

Related U.S. Application Data
(63) Continuation of application No. PCT/JP2023/026909, filed on Jul. 22, 2023.

(30) Foreign Application Priority Data
Aug. 23, 2022 (JP) 2022-132155

(51) Int. Cl. H01F 27/29; H01F 27/30

(52) U.S. Cl. CPC H01F 27/292; H01F 27/306

(57) ABSTRACT

A winding coil component including a core, a wire wound around the core, and a structure where metal terminals attached to flange portions of the core are less easily removable from the flange portions. Each flange portion of a core has a mount surface that is to face a mount board when the coil component is to be mounted on the mount board, a top surface facing in an opposite direction to the mount surface, an inner end surface coupling the mount surface and the top surface to each other, facing the winding core, and at which a corresponding one of the end portions of the winding core in an axial direction is located, an outer end surface facing in an opposite direction to the inner end surface, and first and second side surfaces coupling the inner and outer end surfaces to each other and facing in opposite directions.

### CROSS-REFERENCE TO RELATED APPLICATIONS

This application claims benefit of priority to International Patent Application No. PCT/JP2023/026909, filed Jul. 22, 2023, and to Japanese Patent Application No. 2022-132155, filed Aug. 23, 2022, the entire contents of each are incorporated herein by reference.

### BACKGROUND

### Technical Field

The present disclosure relates to a winding coil component having a structure including a core and a wire wound around the core, and particularly to a metal terminal formed from a metal plate attached to a core.

### Background Art

For example, Japanese Unexamined Patent Application Publication No. 2006-4989 describes a winding coil component having a structure including a core and a wire wound around the core. More specifically, the core includes a winding core extending in an axial direction, and a pair of flange portions disposed at opposite end portions of the winding core in the axial direction. A metal terminal formed from a metal plate is attached to each flange portion. A wire is wound around the winding core, and connected to the metal terminals.

Each flange portion includes a mount surface that is to face a mount board when the coil component is to be mounted on the mount board, a top surface facing in an opposite direction to the mount surface, an inner end surface coupling the mount surface and the top surface to each other, facing the winding core, and at which a corresponding one of the end portions of the winding core in the axial direction is located, and an outer end surface facing in an opposite direction to the inner end surface.

Each metal terminal includes a mount-surface facing portion, an outer-end-surface facing portion, and a top-surface facing portion respectively facing the mount surface, the outer end surface, and the top surface of the corresponding flange portion. The mount-surface facing portion is continuous to the outer-end-surface facing portion with a bent portion interposed therebetween, and the outer-end-surface facing portion is continuous to the top-surface facing portion with a bent portion interposed therebetween.

As described in Japanese Unexamined Patent Application Publication No. 2006-4989, at least one of an angle formed by the outer end surface and the mount surface of each flange portion and an angle formed by the outer end surface and the top surface of the flange portion is an acute angle. Thus, the mount-surface facing portion and the top-surface facing portion hold the corresponding flange portion therebetween to make the corresponding metal terminal less easily removable from the flange portion.

Japanese Unexamined Patent Application Publication No. 2006-4989 also describes a structure where the mount surface and the top surface of each flange portion each have a recess with a circular opening, and the mount-surface facing portion and the top-surface facing portion of each metal terminal each have a protrusion with a spherical surface. When each protrusion is fitted in the corresponding recess, positioning of each metal terminal relative to the corresponding flange portion is facilitated, and misalignment of the metal terminal relative to the flange portion is less likely to occur. This structure is thought to also contribute to less easy removal of each metal terminal from the corresponding flange portion.

### SUMMARY

Directions of external forces exerted on the core, more specifically, directions of external forces causing misalignment of each metal terminal from the corresponding flange portion are typically thought to be six directions. More specifically, the directions include positive and negative two directions of the axial direction (hereafter also referred to as “an L-direction”) of the winding core, positive and negative two directions of the direction orthogonal to the L-direction and connecting the mount surface and the top surface to each other (hereafter also referred to as “a T-direction”), and positive and negative two directions of the direction in which the mount surface and the top surface extend (hereafter also referred to as “a W-direction”). To make each metal terminal less easily removable from the corresponding flange portion, the metal terminal needs to withstand the external forces in these six directions. The external force in the T-direction from the mount surface toward the top surface does not normally occur when the coil component is mounted on the mount board, and thus can be ignored.

In the coil component described in Japanese Unexamined Patent Application Publication No. 2006-4989, each metal terminal of the pair of metal terminals includes the mount-surface facing portion, the outer-end-surface facing portion, and the top-surface facing portion. Thus, the coil component is thought to be able to fully withstand the external forces in four directions including the positive and negative two directions in the T-direction and the positive and negative two directions in the L-direction, with a contact between specific surfaces of each metal terminal and specific surfaces of the corresponding flange portion.

In contrast, no component can achieve surface contact that can withstand the external forces in the positive and negative two directions in the W-direction. In Japanese Unexamined Patent Application Publication No. 2006-4989, as described above, the mount surface and the top surface of each flange portion each have a recess with a circular opening, and the mount-surface facing portion and the top-surface facing portion of each metal terminal each have a protrusion with a spherical surface. However, the resistance, against the external force, caused when the protrusion is fitted in the recess is weaker than the resistance, against the external force, caused when the surfaces come into contact, and thus may fail to fully prevent removal of the metal terminal from the flange portion.

Thus, the present disclosure aims to provide a coil component with a structure capable of further reducing the removability of the metal terminal from the flange portion than the technique described in Japanese Unexamined Patent Application Publication No. 2006-4989.

The present disclosure is directed to a coil component that includes a core including a winding core extending in an axial direction and a pair of flange portions disposed at opposite end portions of the winding core in the axial direction, one pair of metal terminals each attached to a corresponding one of the flange portions, the metal terminals each being formed from a metal plate, and a wire connected to each of the metal terminals of the pair of metal terminals, the wire being wound around the winding core.

Each flange portion has a mount surface that is to face a mount board when the coil component is to be mounted on the mount board, a top surface facing in an opposite direction to the mount surface, an inner end surface coupling the mount surface and the top surface to each other, facing the winding core, and at which a corresponding one of the end portions of the winding core in the axial direction is located, an outer end surface facing in an opposite direction to the inner end surface, and a first side surface and a second side surface coupling the inner end surface and the outer end surface to each other and facing in opposite directions.

In this disclosure, to address the above technical issue, each metal terminal includes a mount-surface facing portion facing a mount surface, an outer-end-surface facing portion facing an outer end surface, a first-side-surface facing portion facing a first side surface, and a second-side-surface facing portion facing a second side surface.

With the surface contact, the coil component according to the present disclosure can withstand the external forces in at least five directions, of the external forces exerted on the core, including the positive and negative two directions in the L-direction, the positive and negative two directions in the W-direction, and the direction from the top surface toward the mount surface in the T-direction. Thus, each metal terminal can fully withstand the external forces in at least the above five directions without being removed from the corresponding flange portion, and thus can further reduce the removability from the flange portion than the technology described in Japanese Unexamined Patent Application Publication No. 2006-4989.

### BRIEF DESCRIPTION OF THE DRAWINGS

FIG. 1 is a perspective view of the external appearance of a coil component according to a first embodiment of the present disclosure, with mount surfaces facing upward;

FIG. 2 is a perspective view of the coil component illustrated in FIG. 1 in a mount state;

FIG. 3 is a perspective view of typical external forces exerted on the coil component when the coil component is in the mount state illustrated in FIG. 2;

FIG. 4 is a perspective view of external forces in the rotational direction exerted on the coil component when the coil component is in the mount state illustrated in FIG. 2;

FIG. 5 is a perspective view of the external appearance of a coil component according to a second embodiment of the present disclosure, with mount surfaces facing upward;

FIG. 6 is a perspective view of the external appearance of a coil component according to a third embodiment of the present disclosure, with mount surfaces facing upward;

FIG. 7 is a perspective view of the external appearance of a coil component according to a fourth embodiment of the present disclosure, with mount surfaces facing upward; and

FIG. 8 is a perspective view of the external appearance of a coil component according to a fifth embodiment of the present disclosure, with mount surfaces facing upward.

### DETAILED DESCRIPTION

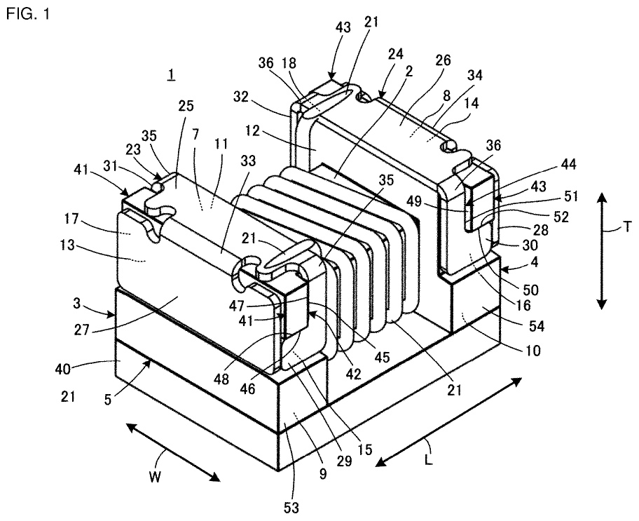

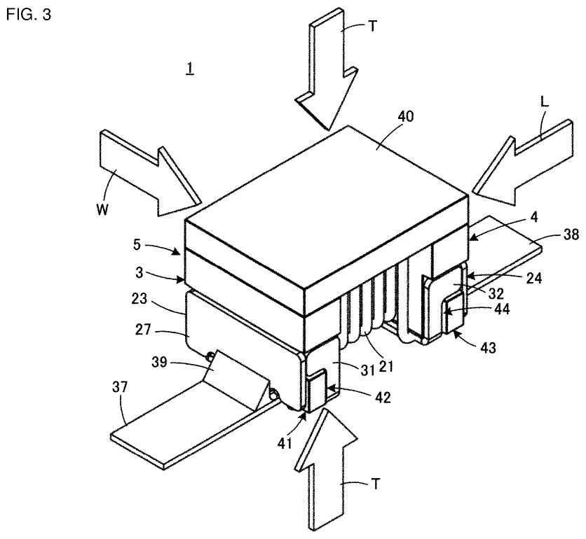

A coil component 1 according to a first embodiment of the present disclosure is described with reference to FIG. 1 to FIG. 4.

The coil component 1 includes a drum-shaped core 5 including a winding core 2 extending in the axial direction (the L-direction) and a pair of flange portions, that is, a first flange portion 3 and a second flange portion 4, disposed at opposite end portions of the winding core 2 in the L-direction. The core 5 is formed from a magnetic body such as ferrite, a resin containing ferrite powder or magnetic metal powder, or a nonmagnetic body such as alumina. In the drawings, the winding core 2 has a substantially quadrilateral cross section, but may have a cross section with another shape such as a polygon including a hexagon, a circle, an ellipse, or a combination of any two or more of these.

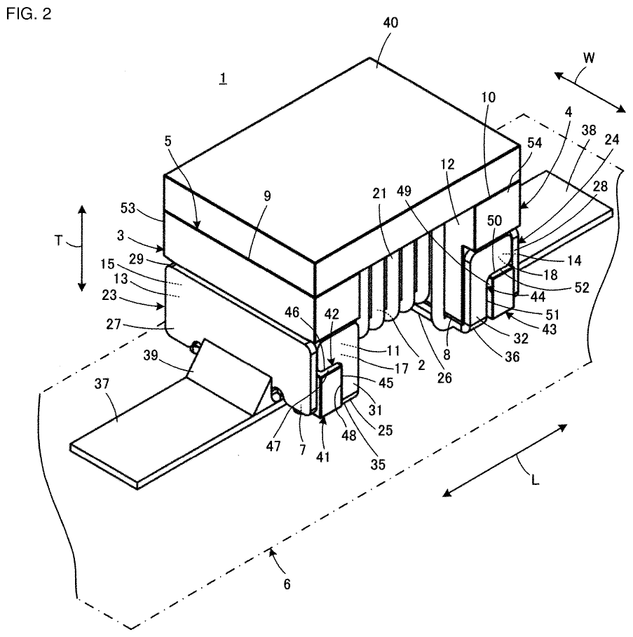

The first flange portion 3 has a mount surface 7 that is to face a mount board 6 (refer to FIG. 2) when the coil component 1 is to be mounted on the mount board 6, a top surface 9 facing in the opposite direction to the mount surface 7, an inner end surface 11 that couples the mount surface 7 and the top surface 9 to each other, that faces the winding core 2, and at which a corresponding one of the end portions of the winding core 2 in the L-direction is located, an outer end surface 13 facing in the opposite direction to the inner end surface 11, and a first side surface 15 and a second side surface 17 that couple the inner end surface 11 and the outer end surface 13 to each other, and that face in opposite directions to each other.

Similarly, the second flange portion 4 has a mount surface 8 that is to face the mount board 6 when the coil component 1 is to be mounted on the mount board 6, a top surface 10 facing in the opposite direction to the mount surface 8, an inner end surface 12 that couples the mount surface 8 and the top surface 10 to each other, that faces the winding core 2, and at which a corresponding one of the end portions of the winding core 2 in the L-direction is located, an outer end surface 14 facing in an opposite direction to the inner end surface 12, and a first side surface 16 and a second side surface 18 that couple the inner end surface 12 and the outer end surface 14 to each other and that face in opposite directions to each other.

Although the dimensions of the core 5 are not limited, for example, the dimension in the L-direction is 3.2 mm, the dimension in a direction orthogonal to the L-direction and in which the mount surfaces 7 and 8 and the top surfaces 9 and 10 extend (the W-direction) is 2.5 mm, and the dimension in a direction connecting the mount surfaces 7 and 8 and the top surfaces 9 and 10 (the T-direction) to one another is 1.8 mm.

The coil component 1 constitutes, for example, a wire-wound inductor, and includes a wire 21 wound around the winding core 2 of the core 5. The wire 21 includes, for example, a wire core formed from a highly electroconductive metal such as copper, silver, or gold, and an insulating coating formed from an electrical insulating resin such as polyamide imide, polyurethane, or polyether imide to cover the wire core. Although the wire core of the wire 21 may have any diameter, the wire core preferably has a diameter of, for example, more than or equal to 80 μm and less than or equal to 200 μm (i.e., from 80 μm to 200 μm). The wire 21 may have any number of turns around the winding core 2.

A pair of metal terminals 23 and 24 are attached to the flange portions 3 and 4. More specifically, a first metal terminal 23 is attached to the first flange portion 3, and a second metal terminal 24 is attached to the second flange portion 4. The first end portion and the second end portion of the above wire 21 that are opposite to each other are respectively connected to the first metal terminal 23 and the second metal terminal 24.

The first metal terminal 23 and the second metal terminal 24 are each formed from a single metal plate, and have substantially the same shape or a shape with point symmetry. As an example of the metal plates used for the metal terminals 23 and 24, a plate obtained by Ni plating and Sn plating a base material formed from phosphor bronze is used.

The first metal terminal 23 has a mount-surface facing portion 25, an outer-end-surface facing portion 27, a first-side-surface facing portion 29, and a second-side-surface facing portion 31 respectively facing the mount surface 7, the outer end surface 13, the first side surface 15, and the second side surface 17 of the first flange portion 3. The second metal terminal 24 has a mount-surface facing portion 26, an outer-end-surface facing portion 28, a first-side-surface facing portion 30, and a second-side-surface facing portion 32 respectively facing the mount surface 8, the outer end surface 14, the first side surface 16, and the second side surface 18 of the second flange portion 4.

In the present embodiment, in the first metal terminal 23, the outer-end-surface facing portion 27 is continuous from the mount-surface facing portion 25 with a first bent portion 33 interposed therebetween, and the first-side-surface facing portion 29 and the second-side-surface facing portion 31 are continuous from the mount-surface facing portion 25 with second bent portions 35 interposed therebetween. Similarly, in the second metal terminal 24, the outer-end-surface facing portion 28 is continuous from the mount-surface facing portion 26 with a first bent portion 34 interposed therebetween, and the first-side-surface facing portion 30 and the second-side-surface facing portion 32 are continuous from the mount-surface facing portion 26 with second bent portions 36 interposed therebetween.

The first end portion and the second end portion of the wire 21 are respectively connected to the mount-surface facing portion 25 of the first metal terminal 23 and the mount-surface facing portion 26 of the second metal terminal 24 by, for example, thermocompression bonding.

As illustrated in FIG. 2, the coil component 1 is mounted on electroconductive lands 37 and 38 disposed on the mount board 6 with solder while the metal terminals 23 and 24 are connected to the coil component 1. FIG. 2 illustrates fillet 39 formed from solder that connects the electroconductive land 37 and the first metal terminal 23 to each other.

The coil component 1 includes a top board 40 disposed to couple the top surface 9 of the first flange portion 3 and the top surface 10 of the second flange portion 4 of the core 5. The top board 40 is joined to the core 5 with an adhesive. A thermosetting epoxy resin is used as an example of the adhesive. To improve thermal shock resistance of the adhesive, an inorganic filler such as a silica filler may be added to the adhesive. The adhesive may be applied by a method such as printing involving an application of the adhesive to the top board 40, dipping the top surfaces 9 and 10 of the flange portions 3 and 4 of the core 5 into the adhesive, or dispensing application of the adhesive to both the top board 40 and the core 5.

As an example of the material of the top board 40, a magnetic body such as ferrite, a resin containing ferrite powder or magnetic metal powder, or a non-magnetic body such as alumina is used. When the core 5 and the top board 40 are both formed from magnetic bodies, the core 5 and the top board 40 form a closed magnetic circuit. Instead of the top board 40, a resin coating may be applied. Alternatively, neither the top board 40 nor a resin coating may be included.

The above structure can achieve the effects described below.

With reference to FIG. 1 to FIG. 4, in a state where the coil component 1 is mounted, the coil component 1 can withstand, of external forces exerted on the core 5, the external forces in the positive and negative two directions of the L-direction using a contact between the outer end surface 13 of the first flange portion 3 and the outer-end-surface facing portion 27 of the first metal terminal 23 and a contact between the outer end surface 14 of the second flange portion 4 and the outer-end-surface facing portion 28 of the second metal terminal 24.

In a state where the coil component 1 is mounted, the coil component 1 can withstand, of the external forces exerted on the core 5, the external forces in the positive and negative two directions of the W-direction using a contact between the first side surface 15 of the first flange portion 3 and the first-side-surface facing portion 29 of the first metal terminal 23, a contact between the second side surface 17 of the first flange portion 3 and the second-side-surface facing portion 31 of the first metal terminal 23, a contact between the first side surface 16 of the second flange portion 4 and the first-side-surface facing portion 30 of the second metal terminal 24, and a contact between the second side surface 18 of the second flange portion 4 and the second-side-surface facing portion 32 of the second metal terminal 24.

In a state where the coil component 1 is mounted, the coil component 1 can withstand, of the external forces exerted on the core 5, the external force in the direction of the T-direction from the top surfaces 9 and 10 toward the mount surfaces 7 and 8 using a contact between the mount surface 7 of the first flange portion 3 and the mount-surface facing portion 25 of the first metal terminal 23 and a contact between the mount surface 8 of the second flange portion 4 and the mount-surface facing portion 26 of the second metal terminal 24.

In the above manner, the coil component 1 can withstand the external forces in at least the above five directions not to remove the metal terminals 23 and 24 from the flange portions 3 and 4.

The present embodiment has a structure that makes the metal terminals 23 and 24 further less removable from the flange portions 3 and 4. More specifically, the coil component 1 according to the present embodiment further includes restrictors to restrict movement of the metal terminals 23 and 24 relative to the flange portions 3 and 4 in at least directions in which the mount-surface facing portions 25 and 26 move away from the mount surfaces 7 and 8.

As described above, of the external forces exerted on the core 5, the external force in the direction of the T-direction from the mount surfaces 7 and 8 toward the top surfaces 9 and 10 does not normally occur in a state where the coil component 1 is mounted on the mount board, but may occur instantaneously due to, for example, a drop impact. The above restrictor is effective against the external force, of the external forces exerted on the core 5, in the direction of the T-direction from the mount surfaces 7 and 8 toward the top surfaces 9 and 10.

More specifically, the restrictor for the first metal terminal 23 is provided by a first protrusion 41 disposed at at least one of the first side surface 15 and the second side surface 17 of the first flange portion 3, and a cut 42 located at at least one of the first-side-surface facing portion 29 and the second-side-surface facing portion 31 of the first metal terminal 23 to receive the first protrusion 41.

The restrictor for the second metal terminal 24 is provided by a first protrusion 43 disposed at at least one of the first side surface 16 and the second side surface 18 of the second flange portion 4, and a cut 44 located at at least one of the first-side-surface facing portion 30 and the second-side-surface facing portion 32 of the second metal terminal 24 to receive the first protrusion 43.

In this manner, at least one of the first-side-surface facing portion 29 and the second-side-surface facing portion 31 of the first metal terminal 23 is selected as a position where the cut 42 is located, and thus, the outer-end-surface facing portion 27 and the mount-surface facing portion 25 of the first metal terminal 23 that receive the external force to a relatively greater extent have a wide area. The same applies to the cut 44 in the second metal terminal 24. This structure can thus further enhance the effect of making the metal terminals 23 and 24 less easily removable from the flange portions 3 and 4.

In the present embodiment, for the first metal terminal 23, the first protrusion 41 is disposed on each of the first side surface 15 and the second side surface 17 of the first flange portion 3, and the cut 42 is located on each of the first-side-surface facing portion 29 and the second-side-surface facing portion 31 of the first metal terminal 23. For the second metal terminal 24, the first protrusion 43 is disposed on each of the first side surface 16 and the second side surface 18 of the second flange portion 4, and the cut 44 is located on each of the first-side-surface facing portion 30 and the second-side-surface facing portion 32 of the second metal terminal 24.

As above, in the structure where the first protrusion 41 is disposed on each of the first side surface 15 and the second side surface 17 of the first flange portion 3 and the first protrusion 43 is disposed on each of the first side surface 16 and the second side surface 18 of the second flange portion 4, the effect of making the metal terminals 23 and 24 less easily removable from the flange portions 3 and 4 can be further enhanced.

The above restrictors formed by combining the first protrusions 41 and 43 and the cuts 42 and 44 can restrict, not only the movement of the mount-surface facing portions 25 and 26 in a direction away from the mount surfaces 7 and 8, but also the movement of the outer-end-surface facing portions 27 and 28 in a direction away from the outer end surfaces 13 and 14.

In the present embodiment, for the first metal terminal 23, the first protrusion 41 provides a first rising wall 45 extending in a direction in which the top surface 9 of the first flange portion 3 and the mount surface 7 face each other, and a second rising wall 46 extending in a direction in which the outer end surface 13 and the inner end surface 11 face each other, and the cut 42 provides a first facing wall 47 facing the first rising wall 45 and a second facing wall 48 facing the second rising wall 46.

For the second metal terminal 24, the first protrusion 43 provides a first rising wall 49 extending in a direction in which the top surface 10 of the second flange portion 4 and the mount surface 8 face each other, and a second rising wall 50 extending in a direction in which the outer end surface 14 and the inner end surface 12 face each other, and the cut 44 provides a first facing wall 51 facing the first rising wall 49 and a second facing wall 52 facing the second rising wall 50.

When the first side surfaces 15 and 16 are viewed in plan and the second side surfaces 17 and 18 are viewed in plan, preferably, the first rising walls 45 and 49 extend linearly in parallel to the inner end surfaces 11 and 12, and the second rising walls 46 and 50 extend linearly in parallel to the mount surfaces 7 and 8.

When, in the above manner, the first rising walls 45 and 49 extend linearly in parallel to the inner end surfaces 11 and 12, and the second rising walls 46 and 50 extend linearly in parallel to the mount surfaces 7 and 8, removal of the metal terminals 23 and 24 from the flange portions 3 and 4 can be reliably reduced without variations in forces in the direction in which the mount-surface facing portions 25 and 26 move away from the mount surfaces 7 and 8 and in the direction in which the outer-end-surface facing portions 27 and 28 move away from the outer end surfaces 13 and 14.

When the first side surface 15 and the second side surface 17 of the first flange portion 3 are viewed in plan, the first protrusions 41 are located on the first side surface 15 and the second side surface 17 to be in contact with a corner where the outer end surface 13 and the mount surface 7 intersect with each other, and the cuts 42 are located a predetermined distance apart from the edges of the first-side-surface facing portion 29 and the second-side-surface facing portion 31 of the first metal terminal 23 located closer to the inner end surface 11 and the edges of the first-side-surface facing portion 29 and the second-side-surface facing portion 31 of the first metal terminal 23 located closer to the top surface 9. In other words, the first-side-surface facing portion 29 and the second-side-surface facing portion 31 have an L shape unevenly located closer to the inner end surface 11 and the top surface 9.

Similarly, when the first side surface 16 and the second side surface 18 of the second flange portion 4 are viewed in plan, the first protrusions 43 are located on the first side surface 16 and the second side surface 18 to be in contact with a corner where the outer end surface 14 and the mount surface 8 intersect with each other, and the cuts 44 are located a predetermined distance apart from the edges of the first-side-surface facing portion 30 and the second-side-surface facing portion 32 of the second metal terminal 24 located closer to the inner end surface 12 and the edges of the first-side-surface facing portion 30 and the second-side-surface facing portion 32 of the second metal terminal 24 located closer to the top surface 10. In other words, the first-side-surface facing portion 30 and the second-side-surface facing portion 32 have an L shape unevenly located closer to the inner end surface 12 and the top surface 10.

With the above arrangement of the first protrusions 41 and 43 and the cuts 42 and 44, the first protrusions 41 and 43 can have a larger area. In addition, the erect walls of the first protrusions 41 and 43 parallel to the mount surfaces 7 and 8 are flush with the mount surfaces 7 and 8, and the erect walls of the first protrusions 41 and 43 parallel to the outer end surfaces 13 and 14 are flush with the outer end surfaces 13 and 14. Thus, the core 5 including the first protrusions 41 and 43 can be easily formed.

The first flange portion 3 preferably further includes a second protrusion 53 that faces at least a part of the edge of the first metal terminal 23 located closer to the top surface 9 in the direction in which the top surface 9 and the mount surface 7 face each other, and the second flange portion 4 preferably further includes a second protrusion 54 that faces at least a part of the edge of the second metal terminal 24 located closer to the top surface 10 in the direction in which the top surface 10 and the mount surface 8 face each other.

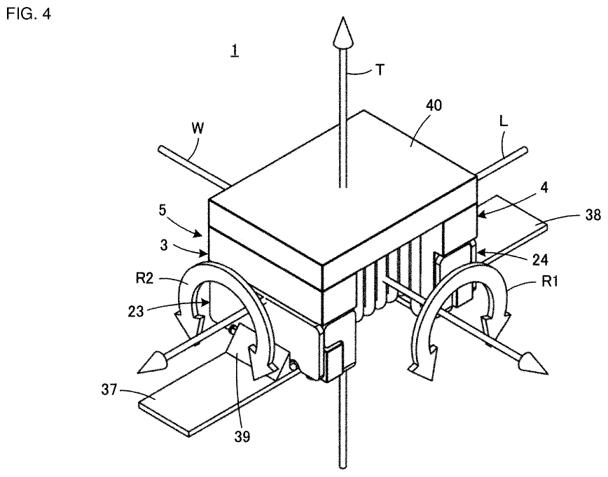

The second protrusions 53 and 54 can more reliably make the metal terminals 23 and 24 less easily removable from the flange portions 3 and 4 against the external forces R1 and R2 in the rotational direction illustrated in FIG. 4. The external force R1 in the rotational direction occurs about the axis in the W-direction, and the external force R2 in the rotational direction occurs about the axis in the L-direction. Among these external forces R1 and R2 in the rotational direction, the external force R1 may occur when, for example, a temperature changes in a state where the coil component 1 is mounted on the mount board 6 and the mount board 6 thermally expands to a greater extent than the core 5 due to a thermal expansion difference between the core 5 and the mount board 6. The external forces R1 and R2 in the rotational direction exert an effect to remove the outer-end-surface facing portions 27 and 28 of the metal terminals 23 and 24 from the core 5, and thus cause removal of the metal terminals 23 and 24 from the flange portions 3 and 4.

In the present embodiment, the second protrusion 53 is disposed over the first side surface 15, the outer end surface 13, and the second side surface 17 of the first flange portion 3, and the second protrusion 54 is disposed over the first side surface 16, the outer end surface 14, and the second side surface 18 of the second flange portion 4.

Regarding the resistance against the external forces R1 and R2 in the rotational direction, particularly, the structure where the second protrusion 53 is disposed to face the edges of the first-side-surface facing portion 29 and the second-side-surface facing portion 31 of the first metal terminal 23 located closer to the top surface 9 and the second protrusion 54 is disposed to face the edges of the first-side-surface facing portion 30 and the second-side-surface facing portion 32 of the second metal terminal 24 located closer to the top surface 10 is effective.

The outer-end-surface facing portions 27 and 28 of the metal terminals 23 and 24 may form steps at portions near the outer end surfaces 13 and 14 of the flange portions 3 and 4, but portions of the second protrusions 53 and 54 located at the outer end surfaces 13 and 14 contribute to elimination or reduction of such steps. Thus, inconvenience such as intrusion of the tips of tweezers into spaces between the outer-end-surface facing portions 27 and 28 of the metal terminals 23 and 24 and the outer end surfaces 13 and 14 of the flange portions 3 and 4 can be reduced.

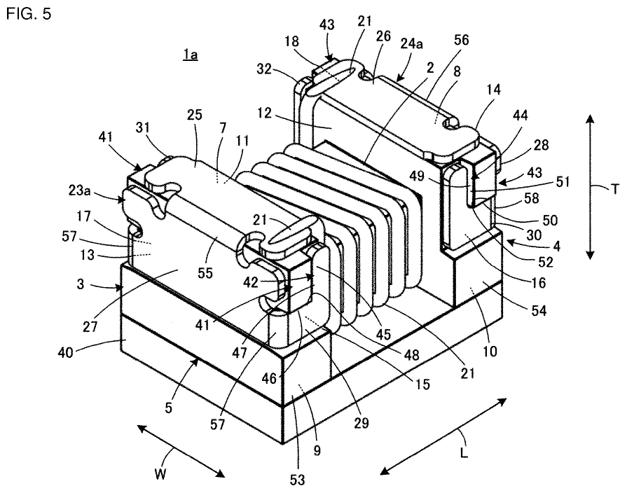

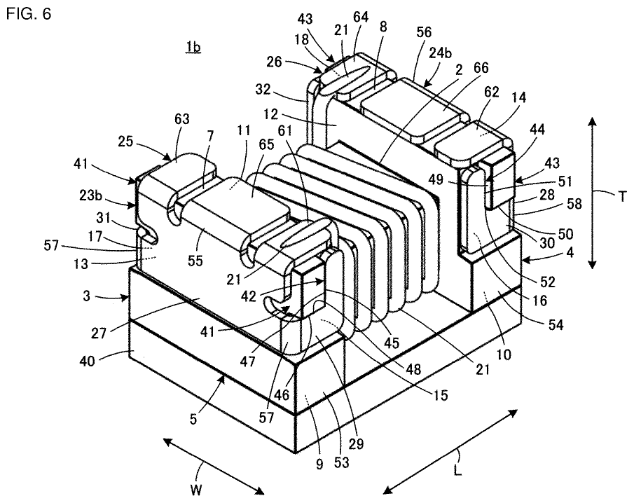

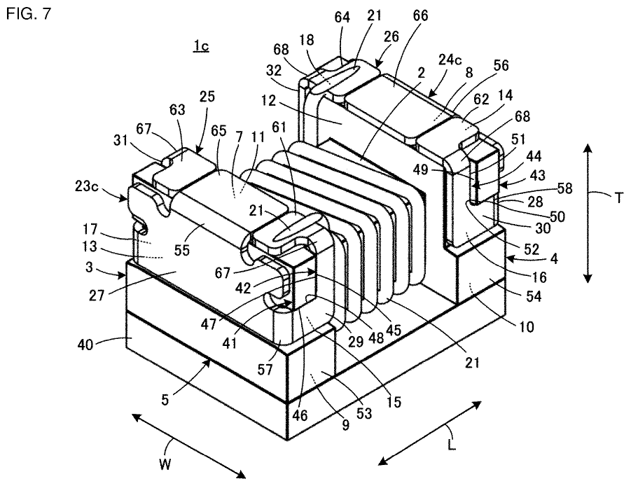

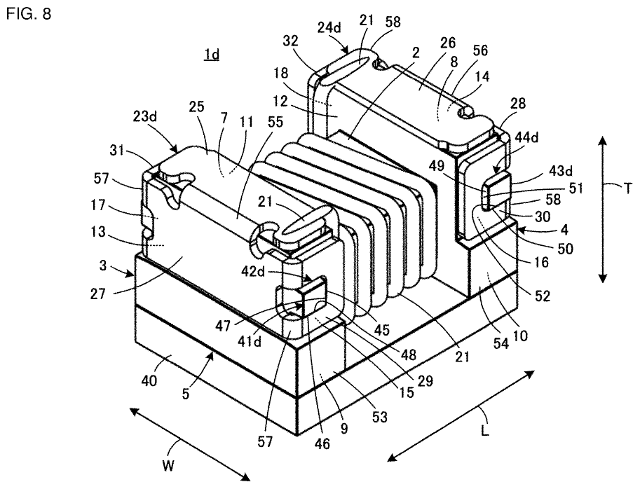

FIG. 5, FIG. 6, FIG. 7, and FIG. 8 each corresponding to FIG. 1 respectively illustrate a coil component 1a according to a second embodiment of the present disclosure, a coil component 1b according to a third embodiment of the present disclosure, a coil component 1c according to a fourth embodiment of the present disclosure, and a coil component 1d according to a fifth embodiment of the present disclosure. In FIG. 5 to FIG. 8, components corresponding to the components illustrated in FIG. 1 or the same components throughout FIG. 5 to FIG. 8 are denoted with the same reference signs and not described repeatedly.

The coil component 1a illustrated in FIG. 5 differs from the coil component 1 illustrated in FIG. 1 in the shape and the bending form of a metal plate used to form each of metal terminals 23a and 24a.

More specifically, in the first metal terminal 23a, the outer-end-surface facing portion 27 is continuous from the mount-surface facing portion 25 with a first bent portion 55 interposed therebetween, and the first-side-surface facing portion 29 and the second-side-surface facing portion 31 are continuous from the outer-end-surface facing portion 27 with second bent portions 57 interposed therebetween.

Similarly, in the second metal terminal 24a, the outer-end-surface facing portion 28 is continuous from the mount-surface facing portion 26 with a first bent portion 56 interposed therebetween, and the first-side-surface facing portion 30 and the second-side-surface facing portion 32 are continuous from the outer-end-surface facing portion 28 with second bent portions 58 interposed therebetween.

The coil component 1b illustrated in FIG. 6 can be regarded as a modification of the coil component 1a illustrated in FIG. 5 with regard to metal terminals 23b and 24b.

More specifically, in the first metal terminal 23b, the mount-surface facing portion 25 is divided into a first mount-surface facing end portion 61 located closer to the first side surface 15, a second mount-surface facing end portion 63 located closer to the second side surface 17, and a mount-surface facing center portion 65 located between the first mount-surface facing end portion 61 and the second mount-surface facing end portion 63. The first mount-surface facing end portion 61, the second mount-surface facing end portion 63, and the mount-surface facing center portion 65 are continuous to the outer-end-surface facing portion 27 with the first bent portion 55 interposed therebetween.

Similarly, in the second metal terminal 24b, the mount-surface facing portion 26 is divided into a first mount-surface facing end portion 62 located closer to the first side surface 16, a second mount-surface facing end portion 64 located closer to the second side surface 18, and a mount-surface facing center portion 66 located between the first mount-surface facing end portion 62 and the second mount-surface facing end portion 64. The first mount-surface facing end portion 62, the second mount-surface facing end portion 64, and the mount-surface facing center portion 66 are continuous to the outer-end-surface facing portion 28 with the first bent portion 56 interposed therebetween.

When the coil component 1b illustrated in FIG. 6 is mounted on a mount board, solder is provided to the mount-surface facing center portions 65 and 66 of the metal terminals 23b and 24b.

In contrast, in the first metal terminal 23b, the first end portion of the wire 21 is connected to either one of the first mount-surface facing end portion 61 and the second mount-surface facing end portion 63, for example, to the first mount-surface facing end portion 61. In the second metal terminal 24b, the second end portion of the wire 21 is connected to either one of the first mount-surface facing end portion 62 and the second mount-surface facing end portion 64, for example, to the second mount-surface facing end portion 64.

As described above, in the coil component 1b illustrated in FIG. 6, the mount-surface facing center portions 65 and 66 to which solder is provided when the coil component is to be mounted, and the first mount-surface facing end portions 61 and 26 or the second mount-surface facing end portions 63 and 64 to which the wire 21 may be connected are isolated from each other. Thus, the first mount-surface facing end portions 61 and 62 or the second mount-surface facing end portions 63 and 64 are less likely to receive the effect of a load such as heat or stress exerted on the mount-surface facing center portions 65 and 66, and the mount-surface facing center portions 65 and 66 are less likely to receive the effect of a load such as heat or stress exerted on the first mount-surface facing end portions 61 and 62 or the second mount-surface facing end portions 63 and 64. Thus, the coil component 1b can enhance the connection security between the mount board and the metal terminals 23b and 24b and the connection security between the metal terminals 23b and 24b and the wire 21.

The coil component 1c illustrated in FIG. 7 can be regarded as a modification of the coil component 1b illustrated in FIG. 6 with regard to metal terminals 23c and 24c.

More specifically, as in the case of the coil component 1b illustrated in FIG. 6, in the first metal terminal 23c, the mount-surface facing portion 25 is divided into a first mount-surface facing end portion 61 located closer to the first side surface 15, a second mount-surface facing end portion 63 located closer to the second side surface 17, and a mount-surface facing center portion 65 located between the first mount-surface facing end portion 61 and the second mount-surface facing end portion 63. The mount-surface facing center portion 65 is continuous to the outer-end-surface facing portion 27 with the first bent portion 55 interposed therebetween, and the first mount-surface facing end portion 61 and the second mount-surface facing end portion 63 are respectively continuous to the first-side-surface facing portion 29 and the second-side-surface facing portion 31 with third bent portions 67 interposed therebetween.

Similarly, in the second metal terminal 24c, the mount-surface facing portion 26 is divided into a first mount-surface facing end portion 62 located closer to the first side surface 16, a second mount-surface facing end portion 64 located closer to the second side surface 18, and a mount-surface facing center portion 66 located between the first mount-surface facing end portion 62 and the second mount-surface facing end portion 64. The mount-surface facing center portion 66 is continuous to the outer-end-surface facing portion 28 with the first bent portion 56 interposed therebetween, and the first mount-surface facing end portion 62 and the second mount-surface facing end portion 64 are respectively continuous with the first-side-surface facing portion 30 and the second-side-surface facing portion 32 with third bent portions 68 interposed therebetween.

As in the case of the coil component 1b illustrated in FIG. 6, when the coil component 1c illustrated in FIG. 7 is mounted on a mount board, solder is provided to the mount-surface facing center portions 65 and 66 of the metal terminals 23c and 24c.

In the first metal terminal 23c, the first end portion of the wire 21 is connected to either the first mount-surface facing end portion 61 or the second mount-surface facing end portion 63, for example, to the first mount-surface facing end portion 61. In the second metal terminal 24c, the second end portion of the wire 21 is connected to either the first mount-surface facing end portion 62 or the second mount-surface facing end portion 64, for example, to the second mount-surface facing end portion 64.

As in the case of the coil component 1b illustrated in FIG. 6, in the coil component 1c illustrated in FIG. 7, the mount-surface facing center portions 65 and 66 to which solder is provided when the coil component is to be mounted and the mount-surface facing end portions 61 to 64 to which the wire 21 may be connected are isolated from one another. However, in the coil component 1c illustrated in FIG. 7, the mount-surface facing end portions 61 to 64 are continuous to the outer-end-surface facing portions 27 and 28 with the side-surface facing portions 29 to 32 interposed therebetween. Thus, compared to the coil component 1b illustrated in FIG. 6, the mount-surface facing end portions 61 to 64 are less likely to be affected by a load such as heat or stress exerted on the mount-surface facing center portions 65 and 66, and the mount-surface facing center portions 65 and 66 are less likely to be affected by a load such as heat or stress exerted on the mount-surface facing end portions 61 to 64. Thus, the coil component 1c can further enhance the connection security between the mount board and the metal terminals 23c and 24c and the connection security between the metal terminals 23c and 24c and the wire 21 than in the case of the coil component 1b illustrated in FIG. 6.

The coil component 1d illustrated in FIG. 8 differs from the coil component 1a illustrated in FIG. 5 in terms of the positions of first protrusions 41d and 43d.

More specifically, in the coil component 1a illustrated in FIG. 5, the first protrusions 41 are located on the first side surface 15 and the second side surface 17 of the first flange portion 3 to be in contact with a corner where the outer end surface 13 and the mount surface 7 intersect, and the first protrusions 43 are located on the first side surface 16 and the second side surface 18 of the second flange portion 4 to be in contact with a corner where the outer end surface 14 and the mount surface 8 intersect. In contrast, in the coil component 1d illustrated in FIG. 8, the first protrusions 41d are located on the first side surface 15 and the second side surface 17 of the first flange portion 3 at a portion apart from a corner where the outer end surface 13 and the mount surface 7 intersect, and the first protrusions 43d are located on the first side surface 16 and the second side surface 18 of the second flange portion 4 at a portion apart from a corner where the outer end surface 14 and the mount surface 8 intersect.

In accordance with changes of the first protrusions 41d and 43d, the positions of cuts 42d and 44d at metal terminals 23d and 24d are changed.

The functions of the first protrusions 41d and 43d are substantially the same as the functions of the first protrusions 41 and 43.

The present disclosure has been described in relation to the illustrated embodiments, but the present disclosure may be embodied with various other embodiments within the range of the present disclosure.

For example, the restrictors for restricting movement of the metal terminals 23 and 24 with respect to the flange portions 3 and 4 in directions in which at least the mount-surface facing portions 25 and 26 move away from the mount surfaces 7 and 8 are not necessary in the present disclosure. However, when at least one restrictor is provided, the restrictor may be disposed in connection with only one of the first side surface 15 and the second side surface 17 of the first flange portion 3, or at least one of the first side surface 16 and the second side surface 18 of the second flange portion 4.

To attach the metal terminals 23 and 24 to the flange portions 3 and 4, no adhesive may be used for fastening in this disclosure. Fastening with an adhesive may encounter a difficulty below.
(1) As the fastening with an adhesive is tighter, the significance of the metal terminals becomes less. The metal terminals are advantageous in that they bend to release stress and prevent breakage regardless of when receiving an external force to some extent due to the elasticity of the metal plates. When the metal terminals are fastened with an adhesive, and as the fastening is tighter, the elasticity of the metal plates becomes less usable. More specifically, the metal terminals become weaker against development of solder cracks in a long-term reliability test or a bending test.
(2) An adhesive is normally weak against heat, and loses its function as an adhesive when receiving heat of approximately 300° C. for a few minutes. However, a manufacture of a coil component including existing metal terminals inevitably involves exertion of heat on the adhesive to connect the wire to the metal terminals with heat after the metal terminals are attached to the core.

In the present disclosure, however, fastening with an adhesive is not necessary to attach the metal terminals 23 and 24 to the flange portions 3 and 4. Thus, the wire can be connected to the metal terminals by sufficient heating. In the coil component, a relatively thick wire may be used. The present disclosure does not exclude use of an adhesive. A coil component according to the present disclosure may be formed by partially replacing or combining components between different embodiments described herein.

The present disclosure includes embodiments described below.
<1> A coil component, comprising a core including a winding core extending in an axial direction and a pair of flange portions disposed at opposite end portions of the winding core in the axial direction; a pair of metal terminals each attached to a corresponding one of the flange portions, the metal terminals each being formed from a metal plate; and a wire connected to each of the metal terminals of the pair of metal terminals, the wire being wound around the winding core. Each of the flange portions has a mount surface that is to face a mount board when the coil component is to be mounted on the mount board, a top surface facing in an opposite direction to the mount surface, an inner end surface coupling the mount surface and the top surface to each other, facing the winding core, and at which a corresponding one of the end portions of the winding core in the axial direction is located, an outer end surface facing in an opposite direction to the inner end surface, and a first side surface and a second side surface coupling the inner end surface and the outer end surface to each other and facing in opposite directions. Each of the metal terminals includes a mount-surface facing portion facing the mount surface, an outer-end-surface facing portion facing the outer end surface, a first-side-surface facing portion facing the first side surface, and a second-side-surface facing portion facing the second side surface.
<2 The coil component according to <1>, wherein the outer-end-surface facing portion is continuous from the mount-surface facing portion with a first bent portion interposed therebetween, and each of the first-side-surface facing portion and the second-side-surface facing portion is continuous from the mount-surface facing portion with a second bent portion interposed therebetween.
<3> The coil component according to <1>, wherein the outer-end-surface facing portion is continuous from the mount-surface facing portion with a first bent portion interposed therebetween, and each of the first-side-surface facing portion and the second-side-surface facing portion is continuous from the outer-end-surface facing portion with a second bent portion interposed therebetween.
<4> The coil component according to <3>, wherein the mount-surface facing portion is divided into a first mount-surface facing end portion located closer to the first side surface, a second mount-surface facing end portion located closer to the second side surface, and a mount-surface facing center portion located between the first mount-surface facing end portion and the second mount-surface facing end portion. Also, each of the first mount-surface facing end portion, the second mount-surface facing end portion, and the mount-surface facing center portion is continuous to the outer-end-surface facing portion with the first bent portion interposed therebetween.
<5> The coil component according to any one of <1> to <4>, further comprising a restrictor that restricts movement of each of the metal terminals with respect to a corresponding one of the flange portions in at least a direction in which the mount-surface facing portion moves away from the mount surface.
<6> The coil component according to <5>, wherein the restrictor is provided by a first protrusion disposed at at least one of the first side surface and the second side surface of each flange portion of the pair of flange portions, and a cut located at at least one of the first-side-surface facing portion and the second-side-surface facing portion of each of the metal terminals to receive the first protrusion.
<7> The coil component according to <6>, wherein the restrictor restricts, in addition to the movement of the mount-surface facing portion in a direction away from the mount surface, movement of the outer-end-surface facing portion in a direction away from the outer end surface.
The coil component according to <6> or <7>, wherein the first protrusion provides a first rising wall extending in a direction in which the top surface and the mount surface face each other, and a second rising wall extending in a direction in which the outer end surface and the inner end surface face each other, and the cut provides a first facing wall facing the first rising wall and a second facing wall facing the second rising wall.
<9> The coil component according to <8>, wherein when each of the first side surface and the second side surface is viewed in plan, the first rising wall extends linearly in parallel to the inner end surface, and the second rising wall extends linearly in parallel to the mount surface.
<10> The coil component according to any one of <6> to <9>, wherein when each of the first side surface and the second side surface is viewed in plan, the first protrusion is located on at least one of the first side surface and the second side surface of each flange portion of the pair of flange portions to be in contact with a corner where the outer end surface and the mount surface intersect with each other. Also, the cut is located a predetermined distance apart from an edge of at least one of the first-side-surface facing portion and the second-side-surface facing portion of the metal terminal located closer to the inner end surface and an edge of the at least one of the first-side-surface facing portion and the second-side-surface facing portion located closer to the top surface.
<11> The coil component according to any one of <5> to <10>, wherein the restrictor is disposed in connection with each of the first side surface and the second side surface of each flange portion of the pair of flange portions.
<12> The coil component according to any one of <1> to <11>, wherein each flange portion of the pair of flange portions further includes a second protrusion that faces at least a part of an edge of each metal terminal located closer to the top surface.
<13> The coil component according to <12>, wherein the second protrusion faces edges of the first-side-surface facing portion and the second-side-surface facing portion of each metal terminal located closer to the top surface.

What is claimed is:

1. A coil component, comprising:
a core including a winding core extending in an axial direction and a pair of flange portions at opposite end portions of the winding core in the axial direction;
a pair of metal terminals each attached to a corresponding one of the flange portions, the metal terminals each being configured from a metal plate; and
a wire connected to each of the metal terminals of the pair of metal terminals, the wire being wound around the winding core,
wherein each of the flange portions has
a mount surface that is to face a mount board when the coil component is to be mounted on the mount board,
a top surface facing in an opposite direction to the mount surface,
an inner end surface coupling the mount surface and the top surface to each other, facing the winding core, and at which a corresponding one of the end portions of the winding core in the axial direction is located,
an outer end surface facing in an opposite direction to the inner end surface, and
a first side surface and a second side surface coupling the inner end surface and the outer end surface to each other and facing in opposite directions,
each of the metal terminals includes
a mount-surface facing portion facing the mount surface,
an outer-end-surface facing portion facing the outer end surface,
a first-side-surface facing portion facing the first side surface, and
a second-side-surface facing portion facing the second side surface.

2. The coil component according to claim 1, wherein
the outer-end-surface facing portion is continuous from the mount-surface facing portion with a first bent portion interposed therebetween, and
each of the first-side-surface facing portion and the second-side-surface facing portion is continuous from the mount-surface facing portion with a second bent portion interposed therebetween.

3. The coil component according to claim 1, wherein
the outer-end-surface facing portion is continuous from the mount-surface facing portion with a first bent portion interposed therebetween, and
each of the first-side-surface facing portion and the second-side-surface facing portion is continuous from the outer-end-surface facing portion with a second bent portion interposed therebetween.

4. The coil component according to claim 3, wherein
the mount-surface facing portion is divided into a first mount-surface facing end portion that is closer to the first side surface, a second mount-surface facing end portion that is closer to the second side surface, and a mount-surface facing center portion between the first mount-surface facing end portion and the second mount-surface facing end portion, and
each of the first mount-surface facing end portion, the second mount-surface facing end portion, and the mount-surface facing center portion is continuous to the outer-end-surface facing portion with the first bent portion interposed therebetween.

5. The coil component according to claim 1, further comprising:
a restrictor configured to restrict movement of each of the metal terminals with respect to a corresponding one of the flange portions in at least a direction in which the mount-surface facing portion moves away from the mount surface.

6. The coil component according to claim 5, wherein
the restrictor includes a first protrusion at at least one of the first side surface and the second side surface of each flange portion of the pair of flange portions, and a cut that is at at least one of the first-side-surface facing portion and the second-side-surface facing portion of each of the metal terminals to receive the first protrusion.

7. The coil component according to claim 6, wherein
the restrictor is configured to restrict, in addition to the movement of the mount-surface facing portion in a direction away from the mount surface, movement of the outer-end-surface facing portion in a direction away from the outer end surface.

8. The coil component according to claim 6, wherein
the first protrusion includes a first rising wall extending in a direction in which the top surface and the mount surface face each other, and a second rising wall extending in a direction in which the outer end surface and the inner end surface face each other, and the cut configures a first facing wall facing the first rising wall and a second facing wall facing the second rising wall.

9. The coil component according to claim 8, wherein
when each of the first side surface and the second side surface is viewed in plan, the first rising wall extends linearly in parallel to the inner end surface, and the second rising wall extends linearly in parallel to the mount surface.

10. The coil component according to claim 6, wherein
when each of the first side surface and the second side surface is viewed in plan, the first protrusion is on at least one of the first side surface and the second side surface of each flange portion of the pair of flange portions to be in contact with a corner where the outer end surface and the mount surface intersect with each other, and
the cut is at a predetermined distance apart from an edge of at least one of the first-side-surface facing portion and the second-side-surface facing portion of the metal terminal that is closer to the inner end surface and an edge of the at least one of the first-side-surface facing portion and the second-side-surface facing portion that is closer to the top surface.

11. The coil component according to claim 5, wherein
the restrictor is in connection with each of the first side surface and the second side surface of each flange portion of the pair of flange portions.

12. The coil component according to claim 1, wherein
each flange portion of the pair of flange portions further includes a second protrusion that faces at least a part of an edge of each metal terminal that is closer to the top surface, in a direction in which the top surface and the mount surface face each other.

13. The coil component according to claim 12, wherein
the second protrusion faces edges of the first-side-surface facing portion and the second-side-surface facing portion of each metal terminal that is closer to the top surface.

14. The coil component according to claim 2, further comprising:
a restrictor configured to restrict movement of each of the metal terminals with respect to a corresponding one of the flange portions in at least a direction in which the mount-surface facing portion moves away from the mount surface.

15. The coil component according to claim 3, further comprising:
a restrictor configured to restrict movement of each of the metal terminals with respect to a corresponding one of the flange portions in at least a direction in which the mount-surface facing portion moves away from the mount surface.

16. The coil component according to claim 7, wherein
the first protrusion includes a first rising wall extending in a direction in which the top surface and the mount surface face each other, and a second rising wall extending in a direction in which the outer end surface and the inner end surface face each other, and the cut configures a first facing wall facing the first rising wall and a second facing wall facing the second rising wall.

17. The coil component according to claim 7, wherein
when each of the first side surface and the second side surface is viewed in plan, the first protrusion is on at least one of the first side surface and the second side surface of each flange portion of the pair of flange portions to be in contact with a corner where the outer end surface and the mount surface intersect with each other, and
the cut is at a predetermined distance apart from an edge of at least one of the first-side-surface facing portion and the second-side-surface facing portion of the metal terminal that is closer to the inner end surface and an edge of the at least one of the first-side-surface facing portion and the second-side-surface facing portion that is closer to the top surface.

18. The coil component according to claim 8, wherein
when each of the first side surface and the second side surface is viewed in plan, the first protrusion is on at least one of the first side surface and the second side surface of each flange portion of the pair of flange portions to be in contact with a corner where the outer end surface and the mount surface intersect with each other, and
the cut is at a predetermined distance apart from an edge of at least one of the first-side-surface facing portion and the second-side-surface facing portion of the metal terminal that is closer to the inner end surface and an edge of the at least one of the first-side-surface facing portion and the second-side-surface facing portion that is closer to the top surface.

19. The coil component according to claim 6, wherein
the restrictor is in connection with each of the first side surface and the second side surface of each flange portion of the pair of flange portions.

20. The coil component according to claim 2, wherein
each flange portion of the pair of flange portions further includes a second protrusion that faces at least a part of an edge of each metal terminal that is closer to the top surface, in a direction in which the top surface and the mount surface face each other.
